(19) United States
(12) Patent Application Publication
(10) Pub. No.: US 2005/0047425 A1
(43) Pub. Date: Mar. 3, 2005

(54) Hierarchical scheduling for communications systems

(76) Inventors: Yonghe Liu, Dallas, TX (US); Matthew B. Shoemake, Allen, TX (US)

Correspondence Address: TEXAS INSTRUMENTS INCORPORATED, P O BOX 655474, M/S 3999, DALLAS, TX, 75265, US

(21) Appl. No.: 10/654,161

(22) Filed: Sep. 3, 2003

(51) Int. Cl. H04L 12/56

(52) U.S. Cl. 370/411; 370/395.4

(57) ABSTRACT

System and method for scheduling messages in a digital communications system with reduced system resource requirements. A preferred embodiment comprises a plurality of traffic queues (such as traffic queue 410) used to enqueue message of differing traffic types and a first scheduler (such as priority scheduler 430). The first scheduler to select messages from the traffic queues and provide them to a plurality of priority queues (such as priority queue 455) used to enqueue messages of differing priorities. A second scheduler (such as priority scheduler 475) then selects messages for transmission based on message priority, transmission opportunity, and time to transmit.

### TECHNICAL FIELD

The present invention relates generally to a system and method for digital communications, and more particularly to a system and method for scheduling messages in a digital communications system with reduced system resource requirements.

### BACKGROUND

In a communications system that supports quality of service (QoS) guarantees and/or prioritized messages, there typically needs to be a significant amount of system resources dedicated to the scheduling of the different priority levels and the QoS classes. Examples of system resources needed to be dedicated may include memory to be used as queues to store the messages prior to transmission, processor cycles to be used to prioritize messages and manage the queues, policing bandwidth usage, scheduling messages, and so forth.

For example, in a wireless communications system that supports QoS and prioritized messages such as one compliant to the EEE 802.11e technical standard, a plurality of different priorities can be supported, such as real-time, medium, and low priorities as well as a best effort priority. For each of these priorities, there may be multiple message streams. The memory space needed to simply queue these messages prior to transmission can be considerable.

A commonly used solution to resource constraints is to simply provide more resources. A more powerful processor can replace a less adequate processor. More memory can also be integrated into the processor. The greater processing power and memory can allow the communications system to support a larger number of message priorities and QoS classes.

One disadvantage of the prior art is that the use of more powerful processors with more memory (and other resources) can increase the overall cost of the communications device since more powerful processor will tend to be more expensive. The additional memory will also cost more.

A second disadvantage of the prior art is that the use of the more powerful processors with more memory can increase the power consumption of the communications device. Should the communications device be a wireless device, then battery life will be shorter. Alternatively, to provide sufficient battery life, newer (and more expensive) battery technologies may be utilized.

A third disadvantage of the prior art is that the even with more powerful processors with more resources, once the communications device is built, the resources become fixed. Therefore, future flexibility of the communications device can be limited.

### SUMMARY OF THE INVENTION

These and other problems are generally solved or circumvented, and technical advantages are generally achieved, by preferred embodiments of the present invention which provides for scheduling of messages in a digital communications system with reduced system resource requirements.

In accordance with a preferred embodiment of the present invention, a method for hierarchical scheduling of prioritized messages comprising at a first level, placing messages of a traffic type based on a specified criteria for the traffic type onto a message queue for the traffic type, wherein there may be multiple traffic types, selecting a message from a message queue based on a priority assigned to each traffic type, providing the selected message to an interface, at a second level, reading the selected message from the interface, placing the read message into one of a plurality of priority queues, and selecting a message from one of the priority queues for transmission when a transmit opportunity is available.

In accordance with another preferred embodiment of the present invention, a hierarchical scheduling system comprising a plurality of traffic queues, each traffic queue containing a plurality of message queues and a queue scheduler, wherein a traffic queue enqueues messages of a single traffic type, wherein each message queue is used to store messages from a single message flow and the queue scheduler orders the messages in the message queues according to a first scheduling algorithm, a first scheduler coupled to each traffic queue, the first priority scheduler containing circuitry to select a message from one of the traffic queues based upon a first serving algorithm, a plurality of priority queues coupled to the first scheduler, wherein each priority queue is used to store messages selected by the first scheduler according to a message's assigned priority level, and a second scheduler coupled to each priority queue, the second scheduler containing circuitry to select a message from one of the priority queues according to a second serving algorithm.

In accordance with another preferred embodiment of the present invention, a communications device comprising a host to process information, the host comprising a plurality of traffic queues, each traffic queue containing a plurality of message queues and a queue scheduler, wherein a traffic queue enqueues messages of a single traffic type, wherein each message queue is used to store messages from a single message flow and the queue scheduler orders the messages in the message queues according to a first scheduling algorithm, a first scheduler coupled to each traffic queue, the first priority scheduler containing circuitry to select a message from one of the traffic queues based upon a first serving algorithm, a station coupled to the host, the station to permit communications between the host and other devices, the station comprising a plurality of priority queues coupled to the first scheduler, wherein each priority queue is used to store messages selected by the first scheduler according to a message's assigned priority level, and a second scheduler coupled to each priority queue, the second scheduler containing circuitry to select a message from one of the priority queues according to a second serving algorithm.

An advantage of a preferred embodiment of the present invention is that different layers of the scheduling hierarchy can reside on different portions of the digital communications system, therefore, a layer requiring a large amount of resources can be placed in a part of the digital communications system with more resources.

A further advantage of a preferred embodiment of the present invention is that layers of the scheduling hierarchy that can be modified to support future modifications to the digital communications system can be placed in software, which can readily be modified. While layers needing rapid performance but not much flexibility can be placed in firmware.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram of an exemplary wireless communications system;

FIG. 2 is a diagram of a quality of service (QoS) enabled layer in a network;

FIG. 3 is a diagram of a high level view of a station and an electronic device coupled to the station, according to a preferred embodiment of the present invention;

FIG. 4 is a diagram of a hierarchical scheduling system for with QoS service and prioritized messages, according to a preferred embodiment of the present invention;

FIG. 5 is an overview of scheduling performed on a host scheduling part of a hierarchical scheduling system, according to a preferred embodiment of the present invention;

FIG. 6 is an overview of scheduling performed on a firmware scheduling part of a hierarchical scheduling system, according to a preferred embodiment of the present invention; and

FIGS. 7a and 7b are flow diagrams illustrating processes for scheduling messages in a hierarchical scheduling system, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a digital wireless communications system adherent to the IEEE 802.11e technical standards. The IEEE 802.11e technical standards are specified in a document entitled “IEEE Std 802.11e/D4.4—Draft Supplement to Standard for Telecommunications and Information Exchange Between Systems—LAN/MAN Specific Requirements—Part 11: Wireless Medium Access Control (MAC) and Physical Layer (PHY) Specifications: Medium Access Control (MAC) Enhancements for Quality of Service (QoS),” published June 2003, which is herein incorporated by reference. The invention may also be applied, however, to other digital communications systems, both wired and wireless, which support QoS and prioritized messages.

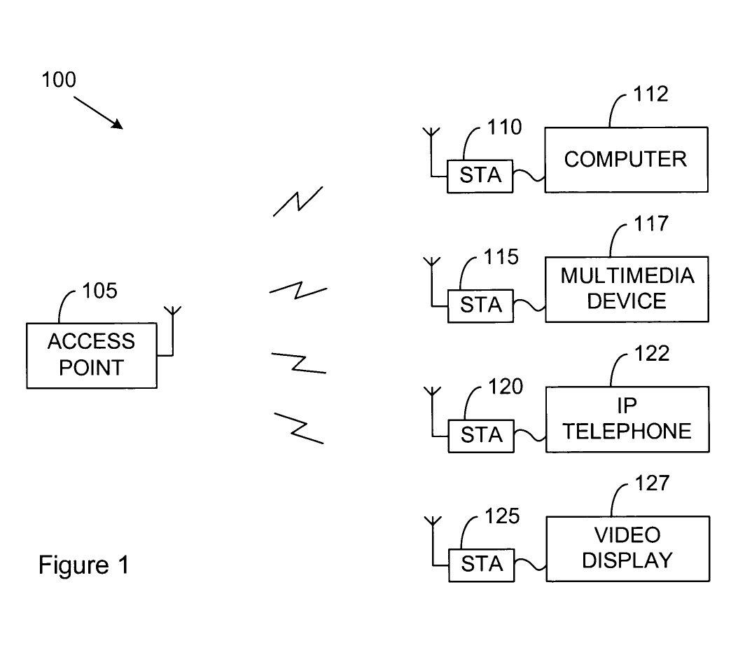

With reference now to FIG. 1, there is shown an exemplary digital wireless communications system 100. The digital wireless communications system 100, as displayed in FIG. 1, is made up of an access point 105, several stations (for example, stations 110, 115, 120, and 125), and several electronic devices coupled to the stations (for example, a computer 112, a multimedia device 117, an IP telephone 122, and a video display 127). The station can be used to establish a wireless communications link between the access point 105 and an electronic device. Note that although displayed in FIG. 1 as being separate entities, in many situations, a station and an electronic device may be integrated into a single unit. For example, many notebook computers and personal digital assistants (PDAs) will have a built-in station to facilitate wireless communications.

In an IEEE 802.11e compliant digital wireless communications network, for example, QoS service and prioritized traffic is supported by the access point 105. The access point 105 serves as a central point for transmissions in the communications network. Transmissions between stations are first sent to the access point 105. The access point 105 also controls access to the communications link, with stations not transmitting until granted permission by the access point 105.

While the access point 105 may serve as the controller, it is up to the individual stations themselves to manage messages originating from electronic devices that are coupled to them. For example, the station 110 must manage message traffic from applications executing on the computer 112, such as web browsers, email programs, file transfers, chats, streaming videos, and so on. A station is required to manage a variety of different message traffic types, such as real-time, streaming, premium data, best effort, and so forth. In addition, each message traffic type may have multiple message streams. For example, the computer 112 may have multiple streaming traffic streams (streaming video and voice) along with several premium data streams (web browser, email programs, file transfers, and so on).

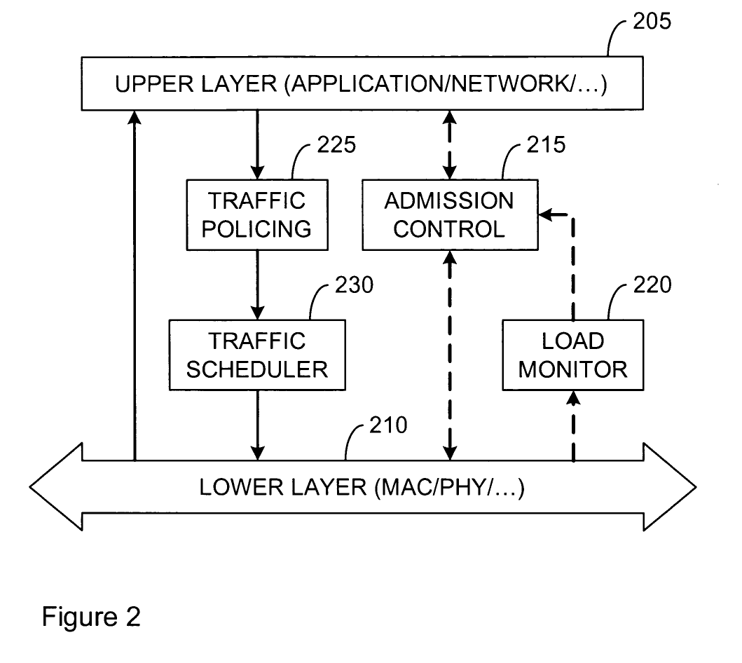

With reference now to FIG. 2, there is shown a diagram illustrating a QoS enabled layer in a network. QoS provisioning is a process of guaranteeing network resources to a particular traffic flow, according to specific requirements of that particular traffic flow. Examples of specific requirements may include a minimum bandwidth, a maximum latency, a maximum jitter, and so on. Providing QoS requires the interaction and coordination of different parties in the network. This may occur vertically between different layers of the network and/or horizontally between similar layers in different networks. The diagram displays an upper layer 205, which can encompass an applications layer and a network layer, i.e., the higher layers of a network. Also displayed is a lower layer 210, encompassing a medium access control (MAC) layer and a physical (PHY) layer.

The process for providing QoS to a certain message flow may be as follows. A request for a certain amount of network resources is initially passed to a QoS enabled resource management entity (not shown) of a layer (from the upper layer 205). Upon receipt of the request, the resource management entity can decide whether to accept or reject the resource request. This decision making process (referred to as an admission control process) can be performed in an entity commonly referred to as an admission control entity (ACE) 215. In order to perform the decision, the ACE 215 may need to monitor the current load on the network and to predict the future requirements. A load monitor 220 may be used to monitor current network load. Additionally, during the admission control process, the ACE 215 may need to negotiate with other ACEs (located in the lower layer 210 or in other networks (not shown)) via a pre-defined signaling protocol. Should the specified requirements cannot be satisfied by all of the parties in a path (between a source of the message flow to a destination of the message flow), the ACE 215 may either require the upper layer 205 to reduce the requirements of its request or reject the request altogether.

Once admitted into the system upon agreement of certain resource requirements (which may be different from the requested amount), the upper layer 205 (or an application in the upper layer 205) can send traffic complying with this agreement. Since bandwidth is one of the most important parameters for QoS enabled flows (a flow may be thought of as a message source), bandwidth should be regulated to prevent ill-behaved/greedy flows from violating the agreement because permitting the ill-behaved flow to do so may affect other flows. This may be implemented in a traffic policing entity 225. The traffic policing entity 225 may permit traffic that conforms to established agreement(s) while stopping traffic that does not conform. The non-conforming traffic may be buffered or simply dropped.

After passing through the traffic policing entity 225, traffic can then be scheduled for access to a communications channel by a traffic scheduler 230. The traffic scheduler 230 may then decide upon the serving order for different packets in the different flows. A commonly used serving order technique is first-in-first-out (FIFO). However, FIFO scheduling generally provides no QoS guarantees. Therefore, other scheduling techniques may be used. They include strict priority (SP), weighted fair queuing (WFQ), and earliest deadline first (EDF).

As the number of traffic flows increase, the amount of processing required to admit, police, and schedule the flows can grow dramatically. The processing may increase to a point where existing system resources cannot accommodate the increased traffic. The increased processing required may exceed available computational resources and the storage (for queuing) may exceed available storage resources on a station.

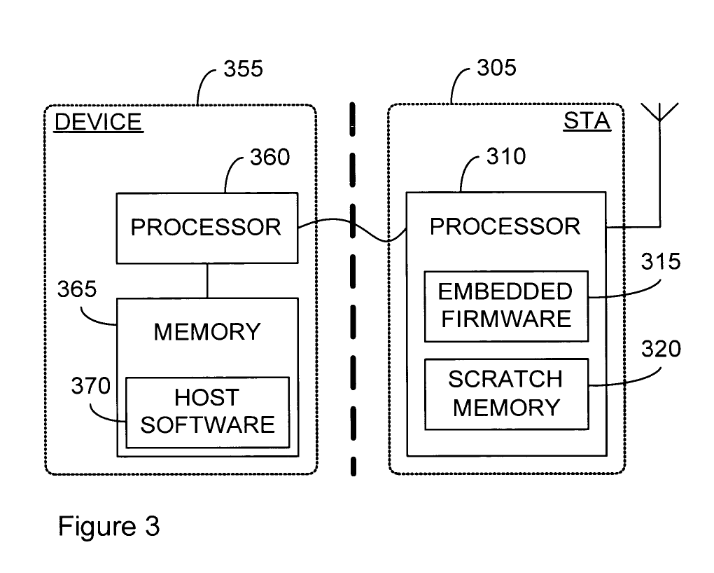

With reference now to FIG. 3, there is shown a diagram illustrating a high level view of a station 305 and an electronic device 355 coupled to the station 305, according to a preferred embodiment of the present invention. Note that the diagram illustrates the processing elements and memories in the station 305 and the electronic device 355, not showing other circuitry. According to a preferred embodiment of the present invention, both the station 305 and the electronic device 355 may have processors 310 and 360, respectively that can be used to provide needed processing capabilities for the two entities. For example, the processor 310 in the station 305 may be used for message management while the processor 360 in the electronic device 355 can be used to process data received by the station 305.

Internally, the processor 310 may have some embedded firmware 315 that can be used to store programs. The processor 310 may have some scratch memory 320 to store data and computation results. Since the embedded firmware 315 and the scratch memory 320 are inside the processor 310, they typically are limited in size. It is typical to size the processor 310 (processing power) and the embedded firmware 315 (storage size) and scratch memory 320 (storage size) so that overall cost and power consumption can be minimized. This means that the processor 310 may not have much processing power to spare and that the embedded firmware 315 and the scratch memory 320 may not have much additional storage capabilities.

Depending on the type of the electronic device 355, for example, the electronic device 355 may be a computer, a PDA, a multimedia device, and so forth, the processor 360 may vary widely in terms of processing power. However, since one of the main tasks of the processor 360 may be to manipulate data, the processor 360 tends to be significantly more powerful than the processor 310 in the station 305. The processor 360 can be coupled to a memory 365. The memory 365 can be used to store programs and data. Since the memory 365 is external to the processor 360, it can be large.

To properly schedule messages, messages from the various traffic streams of the various traffic stream types may need to be queued and then prioritized. Once prioritized, the messages can be transmitted in a specified order to ensure that QoS requirements and message priorities are met. Because of the limited processing power and memory storage capabilities of the processor 310 in the station 305, the station 305 may not be able to fully manage the scheduling of the messages. Furthermore, the embedded firmware 315 does not lend itself to much flexibility, since changes in the embedded firmware 315 can involve the reprogramming of the station 305. Therefore changes in the message traffic types, addition of additional queues, and so forth can be difficult to accomplish.

The processor 360, on the other hand, features more processing power than the processor 310 and the memory 365 can be much larger than the embedded firmware 315. Therefore, the processor 360 can be used to perform some of the message scheduling. According to a preferred embodiment of the present invention, the processor 360 can execute software to allow it to perform some of the message scheduling duties normally performed by the station 305. Host software 370, which may be stored in the memory 365, can be executed by the processor 360 to allow the processor 360 perform some of the message scheduling. Since the host software 370 can be stored in the memory 365, it can be readily updated should changes be made in the message scheduling algorithms, the number and type of traffic streams supported, the total number of message streams supported, the size of the message queues, and so forth.

According to a preferred embodiment of the present invention, since the embedded firmware 315 tends to perform better (lower memory access latencies, less processor overhead, etc.) real-time functions should be performed in the embedded firmware 315 while non-real-time functions should be executed by the host software 370. Examples of real-time functions may include scheduling of the next transmission frame to be transmitted on the wireless channel, rejecting/granting piggy-backed transmit opportunity (TXOP) requests, dropping/retransmitting failed frames, scaling the TXOP according to the current transmission rate, and so on. Non-real-time functions may include admission control, periodic poll generation, scheduling frames for the embedded firmware 315, traffic policing, and so on.

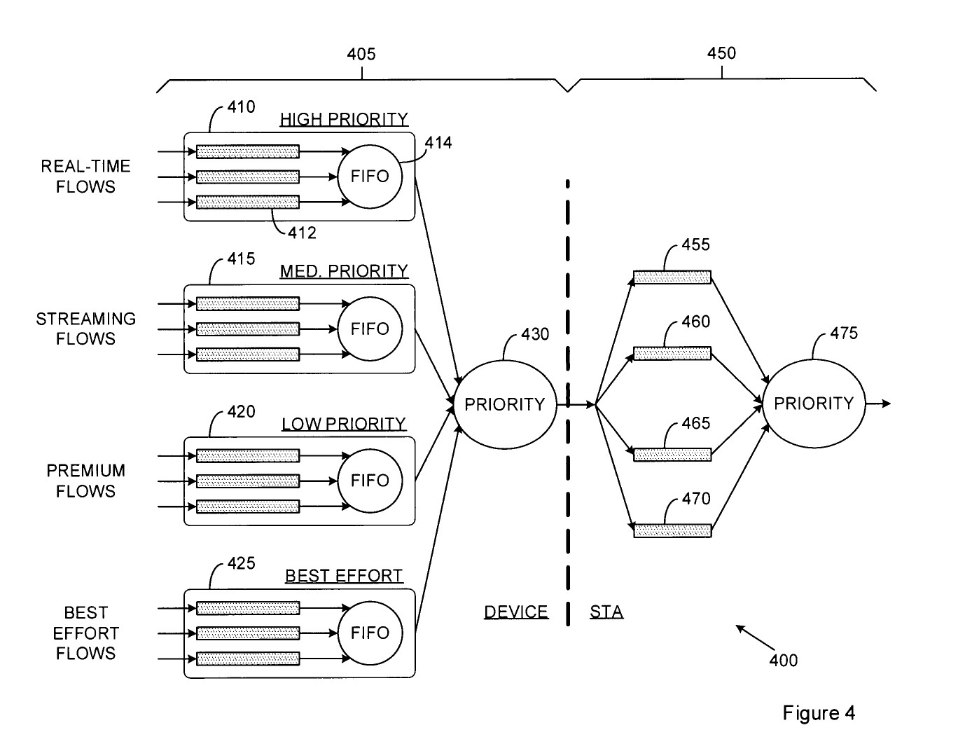

With reference now to FIG. 4, there is shown a diagram illustrating a hierarchical scheduling system 400 for use with QoS service and prioritized messages, according to a preferred embodiment of the present invention. As discussed above, to achieve a good balance of performance and flexibility, a portion of the task of scheduling messages can be performed in embedded firmware located on a station (such as the station 305 (FIG. 3)) while another portion of the task can be performed via host software executing in an electronic device (such as the electronic device 355 (FIG. 3)). The use of embedded firmware provides good performance when timing critical performance is needed while host software executing in an electronic device can provide a measure of flexibility to permit changes to be made in the message scheduling and so forth.

The hierarchical scheduling system 400 can be partitioned into two parts, a host scheduling part 405 and a firmware scheduling part 450. The host scheduling part 405 can be implemented on the electronic device 355 coupled to the station 305. The firmware scheduling part 450 can be implemented in embedded firmware (such as the embedded firmware 315) of the station 305. The host scheduling part 405 can be used to schedule traffic types (such as real-time, streaming, premium data, best effort, and so on) and create a prioritized queue for messages in the various traffic types. Each traffic type can have varying bandwidth demands along with different traffic characteristics. For example, real-time traffic (such as voice) typically requires low delay with low jitter and can be characterized as either a constant bit rate or variable bit rate with relatively low bandwidth requirements. Streaming traffic (such as video), on the other hand, requires medium delay with medium jitter with relatively high bandwidth requirements with a minimum guaranteed bandwidth to prevent buffer under-run. Premium data traffic (such as premium web browsing, FTP, email) has medium delay and jitter requirements with traffic that has a minimum required bandwidth to ensure satisfactory performance. While best effort traffic (such as web browsing, FTP, email) typically has no minimum bandwidth requirements but has traffic that can be characterized as being bursty.

Additionally, for each traffic type, there may be multiple streams. For example, there may be multiple applications generating real-time traffic streams. The multiple message streams can be combined with other message streams of the same traffic type and placed into a message queue (for example, a high priority message queue 410 for real-time traffic flows). Each traffic type may have a message queue and each message queue may be able to process messages from several different flows. According to a preferred embodiment of the present invention, the message queues (such as the high priority message queue 410) implements a first-in first-out (FIFO) queue scheduling algorithm.

According to a preferred embodiment of the present invention, each of the message queues is given a priority. For example, a message queue associated with real-time traffic flows (message queue 410) is assigned a high priority. Messages in the FIFOs of each of the message queues can then be scheduled in a priority queue scheduler 430. The priority queue scheduler 430 can take messages from the various message queues and order them based on their priority. For example, if messages are present in a message queue with a high priority and a message queue with a low priority, then the priority queue scheduler 430 can order messages with a high priority in front of messages with a low priority. The priority queue scheduler 430 may be subject to bandwidth policing constraints to prevent a starvation situation from occurring when low priority messages are prevented from being inserted into the priority queue scheduler 430 by an overwhelming number of messages with a higher priority.

Output of the priority queue scheduler 430 can then be provided to the firmware scheduling part 450, which can take place in the firmware of a station. According to a preferred embodiment of the present invention, a shared memory (not shown) that can be shared by both the host scheduling part 405 and the firmware scheduling part 450, may serve as an interface between the host and the station. The output of the priority queue scheduler 430 may be written to the shared memory which can then be read by the firmware scheduling part 450. The firmware scheduling can take the output of the priority queue scheduler 430 (prioritized traffic that has been bandwidth policed to prevent situations such as starvation and which has been written to the shared memory) and may insert the prioritized traffic into priority queues (such as priority queues 455 and 460) based on the traffic's priority. In fact, the priority queues of the host scheduling part 405 (such as high priority queue 410) themselves, may be stored in the shared memory. The placement of the priority queues into the shared memory can permit the rapid transfer of the queued messages from the host to the station via the simple passing of a reference pointer to a memory location where the message is located.

According to a preferred embodiment of the present invention, the firmware scheduling part 450 may have as many priority queues as there are individual traffic priorities. Note that since the firmware scheduling part 450 queues only messages based on their priorities and not traffic type and individual streams, the number of queues and the amount of storage needed can be smaller. The priority queues in the firmware scheduling part 450 may be sized so that there is sufficient queue storage for the anticipated network traffic load and that a sufficient number of priority queues are available to support the message priorities supported in the network. For example, as displayed in FIG. 4, the firmware scheduling part 450 can have four priority queues, a high priority queue 455, a medium priority queue 460, a low priority queue 465, and a best effort priority queue 470. A priority queue scheduler 475 in the firmware scheduling part 450 can then provide access to the communications channel for messages stored in the priority queues by scheduling transmission frames onto the communications channel. Once again, the priority queue scheduler 475 may be subject to bandwidth policing constraints.

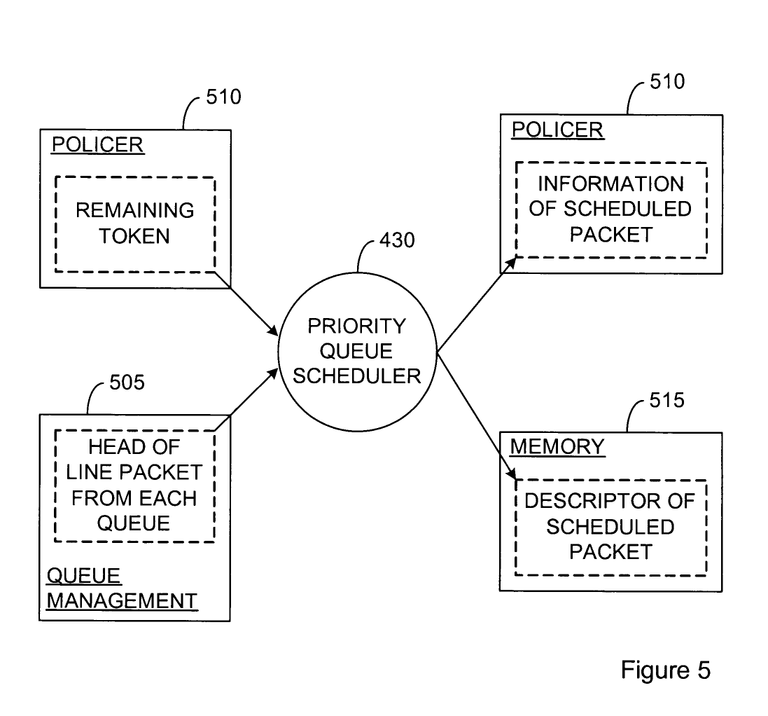

With reference now to FIG. 5, there is shown a diagram illustrating an overview of scheduling performed on the host scheduling part 405, according to a preferred embodiment of the present invention. The priority queue scheduler 430 of the host scheduling part 405 can receive as input, packets at the head of each priority queue (such as the high priority queue 410, the medium priority queue 415, and so on). This may be provided to the priority queue scheduler 430 by a queue management entity 505, which may be responsible for creating and maintaining the various priority queues. According to a preferred embodiment of the present invention, the priority queue scheduler 430 may receive a reference pointer to the packets and not the packets themselves. The priority queue scheduler 430 may also receive remaining token information from a bandwidth policer 510. The remaining token may denote the amount of time/traffic the flow can still transmit on the channel. It may come from an entity used to regulate flows, such as the bandwidth policer 510. As described previously, the bandwidth policer 510 can be used to ensure that various traffic flows adhere to their agreed upon bandwidth allocation.

With the packets at the heads of each priority queue (at least the priority queues with messages queued) and the remaining token, the priority queue scheduler 430 selects the next packet to be provided to the host scheduling part 450. As discussed previously, the priority queue scheduler 430 may select the next packet to be provided based upon many factors, such as the packet's priority, packet wait times, information from the bandwidth policer 510, and so on. After selecting the next packet to provide to the host scheduling part 450, the priority queue scheduler 430 can provide a description of the selected packet to a shared memory 515. This effectively transfers the selected packet to the host scheduling part 450. Alternatively, the priority queue scheduler 430 may provide the selected packet to the shared memory 515. The priority queue scheduler 430 can also provide information about the selected packet to the bandwidth policer 510, which can use the information to update its token.

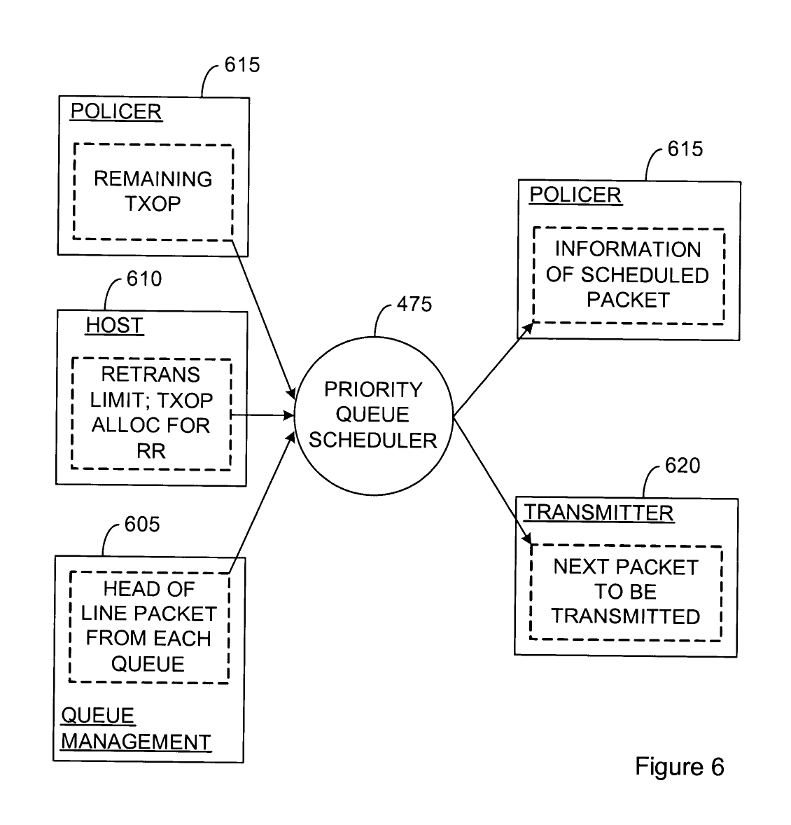

With reference now to FIG. 6, there is shown a diagram illustrating an overview of scheduling performed on the firmware scheduling part 450, according to a preferred embodiment of the present invention. The priority queue scheduler 475 of the firmware scheduling part 450 can receive as input, packets at the head of each priority queue (such as priority queues 455 and 460 and others). This may be provided to the priority queue scheduler 475 by a queue management entity 605, which can be responsible for creating and maintaining the various priority queues. The priority queue scheduler 475 may also receive information from the host 610. Information from the host may include a limit on the number of retransmit attempts, a transmission opportunity allocation for round robin scheduling, and so forth. Furthermore, from a bandwidth policer 615, the priority queue scheduler 475 may receive information related to a remaining transmission opportunity.

The priority queue scheduler 475 can then determine the next packet to be transferred to the communications channel. After selecting the packet, the priority queue scheduler 475 can provide information about the selected packet to the bandwidth policer 615, which can use the information to update information it is maintaining regarding bandwidth usage of the various traffic flows. The priority queue scheduler 475 can also provide the selected packet to a transmitter 620. As discussed previously, the priority queue scheduler 475 may provide a reference pointer to the selected packet to the transmitter 620 or it may provide the packet itself to the transmitter 620. With the selected packet at the transmitter 620, the transmitter 620 can attempt to transmit the selected packet at a predetermined transmission time.

How a packet is scheduled can vary depending upon the traffic type of the packet. As discussed previously, a preferred embodiment of the present invention provides support for four different traffic types (real-time, streaming, premium data, and best effort), with the ability to provide support for additional traffic types should the need arise. Host scheduling part and firmware scheduling part operations can also be different for a given traffic type.

When a packet is of type real-time, then the host scheduling part 405 can schedule the packet with the highest priority. When there are multiple real-time message flows, then the different packets of the message flows can be scheduled in FIFO manner. In the firmware scheduling part 450, the main objective may be to deliver the packets as close to the prespecified time as possible to reduce delay and jitter. The firmware scheduling part 450 should maintain next scheduled serving times for both uplink poll and downlink data of real-time traffic. Making use of the scheduled serving times, the firmware scheduling part 450 should limit transmission opportunity allocations for certain flows to avoid long occupations of the communications channel and violation of real-time service requirements.

If a packet is of type streaming, then the host scheduling part 405 may not need to use look ahead scheduling since a large transmission opportunity allocation should not disturb the streaming service. Streaming type packets can be assigned the second to highest priority and when there are multiple streaming message flows, a scheduling algorithm such as earliest deadline first (EDF) should be used to order the packets from the different streams. The firmware scheduling part 450 should schedule the streaming priority queue as long as the real-time serving interval is not reached.

Should a packet be of type premium data, then the host scheduling part 405 can use a scheduling algorithm such as weighted fair queuing or a variant to ensure a minimum bandwidth and fair allocation among flows. Note that bandwidth should be allocated fairly among premium data flows after serving real-time and streaming flows. The firmware scheduling part 450 serves the packets at the predefined priority (third highest).

When a packet is of type best effort, then the host scheduling part 405 can schedule best effort packets after higher priority packets have been scheduled. Similarly, the firmware scheduling part 450 should serve best effort packets after serving higher priority packets.

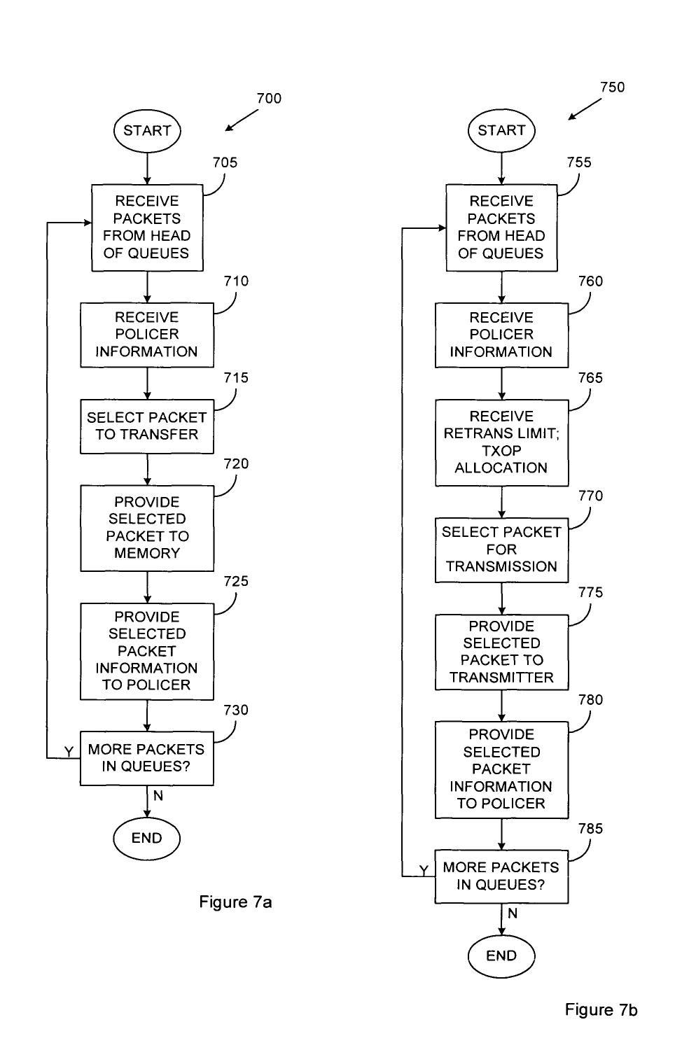

With reference now to FIGS. 7a and 7b, there are shown flow diagrams illustrating processes for scheduling packets in the host scheduling part 405 and the firmware scheduling part 450, according to a preferred embodiment of the present invention. A first process 700 illustrates the scheduling of packets in the host scheduling part 405. According to a preferred embodiment of the present invention, the first process 700 can be illustrative of a sequence of operations taking place in a priority queue scheduler 430. The first process 700 begins when there is at least one packet in a priority queue. The priority queue scheduler 430 can receive packets at the head of priority queues which have packets (block 705). In addition, the priority queue scheduler 430 can also receive information from a bandwidth policer regarding remaining tokens (block 710).

With this information, the priority queue scheduler 430 can select a packet to transfer to the firmware queue scheduler 475 (block 715). The priority queue scheduler 430 can typically select packets based on the packet's priority. However, other factors may be considered, such as arrival time, “weight” of the packet (i.e., its importance), whether or not the flow to which the packet belongs has violated bandwidth restrictions, and so forth. After selecting the packet (block 715), the priority queue scheduler 430 can provide the selected packet to a shared memory (block 720), which can operate as an interface between the host scheduling part 405 and the firmware scheduling part 450. The priority queue scheduler 430 can also provide information regarding the selected packet to the bandwidth policer (block 725), which can use the information to update its own information. Finally, the priority queue scheduler 430 can check to see if additional packets remain in the priority queues (block 730). If there are additional packets, the priority queue scheduler 430 can return to block 705 to begin selecting another packet.

A second process 750 illustrates the scheduling of packets in the firmware scheduling part 450. According to a preferred embodiment of the present invention, the second process can be illustrative of a sequence of operations taking place in a priority queue scheduler 475. The second process 750 begins when there is at least one packet in a priority queue. The priority queue scheduler 475 can receive packets at the head of priority queues which have packets (block 755). Additionally, the priority queue scheduler 475 can receive information from a bandwidth policer regarding a remaining transmission opportunity (block 760) and from the host regarding retransmission limits and transmission opportunity allocations for round robin operation (block 765).

With this information, the priority queue scheduler 475 can select a packet for transmission (block 770). After selecting the packet, the priority queue scheduler 475 can provide the selected packet to a transmitter (block 775). The priority queue scheduler 475 can also provide information about the selected packet to the bandwidth policer (block 780), which uses the information to update its own information. Finally, the priority queue scheduler 475 checks to see if there are additional packets to transmit (block 785). If there are additional packets to transmit, the priority queue scheduler 475 can return to block 755 to select another packet.

Note that the first and the second processes 700 and 750 may be illustrating operations that can be operating simultaneously with one another. Additionally, the two processes can operate independently of one another, as long as there are packets in priority queues to be scheduled, the operations illustrated in the processes can proceed.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for hierarchical scheduling of prioritized messages comprising:
at a first level,
placing messages of a traffic type based on a specified criteria for the traffic type onto a message queue for the traffic type, wherein there may be multiple traffic types;
selecting a message from a message queue based on a priority assigned to each traffic type;
providing the selected message to an interface;
at a second level,
reading the selected message from the interface;
placing the read message into one of a plurality of priority queues; and
selecting a message from one of the priority queues for transmission when a transmit opportunity is available.

2. The method of claim 1, wherein for each traffic type, there may be multiple message streams, and wherein messages from different message streams of each traffic type is placed in the message queue.

3. The method of claim 2, wherein messages from different message streams are placed in the queue in a first-come first-served (FIFO) order.

4. The method of claim 2, wherein messages from different message streams are placed in the queue based on a weighing of the different message streams.

5. The method of claim 1, wherein the message selected in the first selecting is the message at a head of a message queue for a traffic type with the highest priority.

6. The method of claim 1, wherein the message selected in the second selecting is the message at a head of a message queue for a traffic type with the highest priority that has a granted transmission opportunity.

7. The method of claim 1, wherein the interface is a shared memory, and wherein the providing comprises writing the selected message to the shared memory.

8. The method of claim 7, wherein the reading comprises retrieving the selected message from the shared memory.

9. The method of claim 1, wherein the interface is a shared memory, and wherein the providing comprises writing a reference pointer to the selected message to the shared memory.

10. The method of claim 9, wherein the reading comprises retrieving the reference pointer and retrieving the selected message stored at a memory location indicated by the reference pointer.

11. The method of claim 1, wherein the transmit opportunity has multiple periods, and wherein in a first period, only the highest priority messages can be transmitted.

12. The method of claim 11, wherein in a second period, any priority message can be transmitted.

13. The method of claim 12, wherein a message of a given priority can be selected only if there are no messages of a higher priority waiting to be transmitted.

14. The method of claim 12, wherein a message of a given priority can be selected only if there are no transmission opportunities for messages of a higher priority.

15. The method of claim 12, wherein a message of a given priority can be selected only if there is insufficient time in the transmission opportunity for messages of higher priorities.

16. The method of claim 1, wherein the placing comprises putting the message into a priority queue assigned to enqueue messages of the same assigned priority.

17. The method of claim 1, wherein the second selecting comprises choosing a message with an assigned priority level equal to that permitted in the transmission opportunity.

18. The method of claim 17, wherein the second selecting further comprises choosing a message with a transmit time shorter than the transmission opportunity.

19. A hierarchical scheduling system comprising:
a plurality of traffic queues, each traffic queue containing a plurality of message queues and a queue scheduler, wherein a traffic queue enqueues messages of a single traffic type, wherein each message queue is used to store messages from a single message flow and the queue scheduler orders the messages in the message queues according to a first scheduling algorithm;
a first scheduler coupled to each traffic queue, the first priority scheduler containing circuitry to select a message from one of the traffic queues based upon a first serving algorithm;
a plurality of priority queues coupled to the first scheduler, wherein each priority queue is used to store messages selected by the first scheduler according to a message's assigned priority level; and
a second scheduler coupled to each priority queue, the second scheduler containing circuitry to select a message from one of the priority queues according to a second serving algorithm.

20. The hierarchical scheduling system of claim 19, wherein the first scheduling algorithm enqueues messages based on their arrival time.

21. The hierarchical scheduling system of claim 20, wherein the first scheduling algorithm also enqueues messages based on a weighting value assigned to each message flow.

22. The hierarchical scheduling system of claim 19, wherein the first serving algorithm selects the message based upon a priority level assigned to each traffic queue.

23. The hierarchical scheduling system of claim 22, wherein the first serving algorithm selects the message based upon information regarding remaining bandwidth allocated for each traffic type.

24. The hierarchical scheduling system of claim 23, wherein information about the selected message is used to adjust the information about the remaining bandwidth allocation.

25. The hierarchical scheduling system of claim 19 further comprising an interface between the first scheduler and the plurality of priority of queues, the interface to allow the exchange of information between the first scheduler and the plurality of priority queues.

26. The hierarchical scheduling system of claim 25, wherein the interface is a shared memory.

27. The hierarchical scheduling system of claim 19, wherein a priority queue can enqueue message from different message flows with equal assigned priority levels.

28. The hierarchical scheduling system of claim 27, wherein a priority queue enqueues messages based on their arrival time.

29. The hierarchical scheduling system of claim 19, wherein the second serving algorithm selects the message based upon an assigned priority level.

30. The hierarchical scheduling system of claim 29, wherein the second serving algorithm selects the message based upon information about which message priority can be transmitted.

31. The hierarchical scheduling system of claim 30, wherein the second serving algorithm selects the message if there is sufficient time to transmit the message.

32. The hierarchical scheduling system of claim 31, wherein information about the selected message is used to adjust the information about remaining time to transmit messages.

33. The hierarchical scheduling system of claim 30, wherein information about the selected message is used to adjust the information about the message priority that can be transmitted.

34. The hierarchical scheduling system of claim 19, wherein messages selected by the second scheduler are provided to a transmitter to transmit to the messages' intended destination.

35. A communications device comprising:
a host to process information, the host comprising
a plurality of traffic queues, each traffic queue containing a plurality of message queues and a queue scheduler, wherein a traffic queue enqueues messages of a single traffic type, wherein each message queue is used to store messages from a single message flow and the queue scheduler orders the messages in the message queues according to a first scheduling algorithm;
a first scheduler coupled to each traffic queue, the first priority scheduler containing circuitry to select a message from one of the traffic queues based upon a first serving algorithm;
a station coupled to the host, the station to permit communications between the host and other devices, the station comprising
a plurality of priority queues coupled to the first scheduler, wherein each priority queue is used to store messages selected by the first scheduler according to a message's assigned priority level; and
a second scheduler coupled to each priority queue, the second scheduler containing circuitry to select a message from one of the priority queues according to a second serving algorithm.

36. The communications device of claim 35 further comprising an interface between the host and the station, the interface to permit an exchange of messages.

37. The communications device of claim 36, wherein the interface is a shared memory.

38. The communications device of claim 35, wherein the plurality of traffic queues is implemented in a memory in the host and the first scheduler is executing in processor in the host.

39. The communications device of claim 35, wherein the plurality of priority queues is implemented in a firmware of the station and the second scheduler is executing in the firmware of the station.

40. The communications device of claim 35, wherein the station is a wireless network adapter.

41. The communications device of claim 40, wherein the wireless network adapter is IEEE 802.11e compliant.

42. The communications device of claim 35, wherein the station is a wired network adapter.
